(19) United States
(12) Patent Application Publication
(10) Pub. No.: US 2024/0159649 A1
(43) Pub. Date: May 16, 2024

(54) FLUID MONITORING METHOD

(71) Applicant: KOREA INSTITUTE OF SCIENCE AND TECHNOLOGY, Seoul (KR)

(72) Inventors: Yong Bok LEE, Seoul (KR); Wonil KWAK, Seoul (KR); YunSeok HA, Seoul (KR); Byul AN, Seoul (KR)

(21) Appl. No.: 18/503,568

(22) Filed: Nov. 7, 2023

(30) Foreign Application Priority Data
Nov. 9, 2022 (KR) 10-2022-0148716

(51) Int. Cl. G01N 15/14; G06T 7/246; G06T 7/285; G06T 7/292; G06T 7/62; G06V 20/60

(52) U.S. Cl. CPC G01N 15/1463; G01N 15/1459; G06T 7/248; G06T 7/285; G06T 7/292; G06T 7/62; G06V 20/60; G01N 2015/1075; G01N 2015/1477; G01N 2015/1493

(57) ABSTRACT

Provided is a fluid monitoring method including photographing a particle in a flowing fluid using a first camera, photographing the particle using a second camera spaced apart from the first camera, and analyzing the particle using images captured by each of the first camera and the second camera, in which the analyzing of the particle includes calculating a volume of the particle, calculating a velocity of the particle moving in the fluid, calculating a density of the particle using the volume and the velocity, and identifying a type of the particle using the density.

### CROSS-REFERENCE TO RELATED APPLICATION

This U.S. non-provisional patent application claims priority under 35 U.S.C. § 119 of Korean Patent Application No. 10-2022-0148716, filed on Nov. 9, 2022, the entire contents of which are hereby incorporated by reference.

### BACKGROUND

The present disclosure herein relates to a fluid monitoring method, and more particularly, to a fluid monitoring method capable of monitoring particles in a fluid.

Fluids may be used in various industrial fields. For example, a certain amount of fluid may be repeatedly circulated in a certain section to drive a rotating machine. The fluid passing through a rotating machine may contain particles that have been shed from a worn machine. By analyzing the particles in the fluid, conditions of the machine may be diagnosed.

### SUMMARY

The present disclosure provides a fluid monitoring method capable of identifying a type of particles in a fluid.

The present disclosure also provides a fluid monitoring method capable of grasping the amount of particles in a fluid in real time.

The present disclosure also provides a fluid monitoring method capable of determining a state of a contaminant contaminating a fluid.

The present disclosure also provides a fluid monitoring method capable of monitoring a fluid with simple equipment.

The present disclosure also provides a fluid monitoring method capable of monitoring a flowing fluid in real time.

The effects of present disclosure are not limited to those mentioned above, and other effects not mentioned will be clearly understood by those skilled in the art from the following description.

An embodiment of the inventive concept provides a fluid monitoring method including photographing a particle in a flowing fluid using a first camera, photographing the particle using a second camera spaced apart from the first camera, and analyzing the particle using images captured by each of the first camera and the second camera, and the analyzing of the particle includes calculating a volume of the particle, calculating a velocity of the particle moving in the fluid, calculating a density of the particle using the volume and the velocity, and identifying a type of the particle using the density.

In an embodiment, the fluid monitoring method may further include identifying a generation source of the particle using information on the identified type of the particle.

In an embodiment, the fluid monitoring method may further include identifying types of a plurality of expected particles to be expected to be present in the fluid, and the identifying of the type of the particle may include selecting one of the plurality of expected particles using the density of the particle.

In an embodiment, the identifying of the type of the particle may be performed using a Young's modulus-density chart.

In an embodiment, each of the photographing of the particle using the first camera and the photographing of the particle using the second camera may be performed at each of a first time and a second time, and the calculating of the velocity of the particle may include calculating the velocity of the particle using a position of the particle at the first time and a position of the particle at the second time.

In an embodiment, each of the photographing of the particle using the first camera and the photographing of the particle using the second camera may be performed on a plurality of particles for a certain period of time.

In an embodiment, the fluid monitoring method may further include calculating an amount of the plurality of particles observed in the fluid for the certain period of time.

In an embodiment, the first camera and the second camera may photograph the particle at different angles.

In an embodiment, the calculating of the volume of the particle may be performed by comparing the image captured by the first camera with the image captured by the second camera.

In an embodiment of the inventive concept, a fluid monitoring method includes photographing a particle in a flowing fluid using a stereo camera and analyzing the particle using an image captured by the stereo camera, and the analyzing of the particle includes calculating a volume of the particle, calculating a velocity of the particle moving in the fluid, and calculating a density of the particle using the volume and the velocity.

In an embodiment, the analyzing of the particle may further include identifying a type of the particle using the density.

In an embodiment, the photographing of the particle using the stereo camera may be performed on a plurality of particles for a certain period of time, and the analyzing of the particle may include comparing buoyant forces of the plurality of particles with each other.

In an embodiment, the identifying of the type of the particle may include correcting the type of the particle identified by the density using a buoyant force of each of the plurality of particles.

In an embodiment, the fluid monitoring method may include connecting an observation flow path disposed in parallel with a main flow path through which the fluid flows to the main flow path, and in the photographing of the particle using the stereo camera, the stereo camera may photograph the particle passing through the observation flow path.

In an embodiment of the inventive concept, a fluid monitoring method includes photographing a plurality of particles in a flowing fluid using a camera and analyzing the plurality of particles using an image captured by the camera, and the analyzing of the plurality of particle includes calculating a volume of each of the plurality of particles, calculating a velocity of each of the plurality of particles moving in the fluid, calculating a density of each of the plurality of particles using the volume and the velocity, comparing a buoyant forces of the plurality of particles with each other, and identifying a type of each of the plurality of particles using the buoyant force and the density.

In an embodiment, the photographing of the plurality of particles using the camera may be performed using a first camera and a second camera spaced apart from the first camera.

In an embodiment, the photographing of the plurality of particles using the camera may be performed using a stereo camera.

Details of other embodiments are included in the Detailed Description and drawings.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept.

In the drawings:

FIG. 1 is a schematic diagram illustrating a fluid monitoring device according to an embodiment of the inventive concept;

FIG. 2 is a perspective view illustrating a fluid observation device according to an embodiment of the inventive concept;

FIG. 3 is a flowchart illustrating a fluid monitoring method according to an embodiment of the inventive concept;

FIGS. 4 and 5 are diagrams illustrating the fluid monitoring method according to an embodiment of the inventive concept according to the flowchart of FIG. 3;

FIG. 6 is a graph showing Young's modulus-density chart;

FIG. 7 is a perspective view showing a fluid observation device according to an embodiment of the inventive concept;

FIG. 8 is a flowchart illustrating a fluid monitoring method according to an embodiment of the inventive concept; and

FIG. 9 is a diagram showing a fluid observation device according to an embodiment of the inventive concept.

### DETAILED DESCRIPTION

In order to fully understand configurations and effects of the present disclosure, embodiments of the inventive concept will be described below in more detail with reference to the accompanying drawings. The inventive concept may, however, be embodied in different forms and be applied with various modifications and should not be construed as limited to the embodiments set forth herein. Rather, these embodiments are provided so that this disclosure will be thorough and complete, and will fully convey the scope of the inventive concept to those skilled in the art.

Like reference numerals throughout the specification refer to like elements in principle. Embodiments described in the specification will be described herein with reference to block diagrams, perspective diagrams, and/or cross-sectional views that are idealized illustrations of the embodiments of the inventive concept. In the drawings, the thicknesses of regions are exaggerated for effective description of the technical contents. Accordingly, the regions illustrated in the drawings have schematic properties, and the shapes of the regions illustrated in the drawings are intended to illustrate a specific shape of a region of an element and are not intended to limit the scope of the inventive concept. It will be understood that, although various terms may be used herein to describe various elements in various embodiments of the present specification, these elements should not be limited by these terms. These terms are only used to distinguish one element from another element. Embodiments described and illustrated herein also include complementary embodiments thereof.

The terminology used herein is for the purpose of describing embodiments only and is not intended to limit the present disclosure. As used herein, the singular forms “a”, “an”, and “the” are intended to include the plural forms as well, unless the context clearly indicates otherwise. It will be further understood that the terms “comprises” and/or “comprising”, when used in this specification, do not preclude the presence or addition of one or more other elements.

Hereinafter, embodiments of the inventive concept will be described in detail with reference to the accompanying drawings.

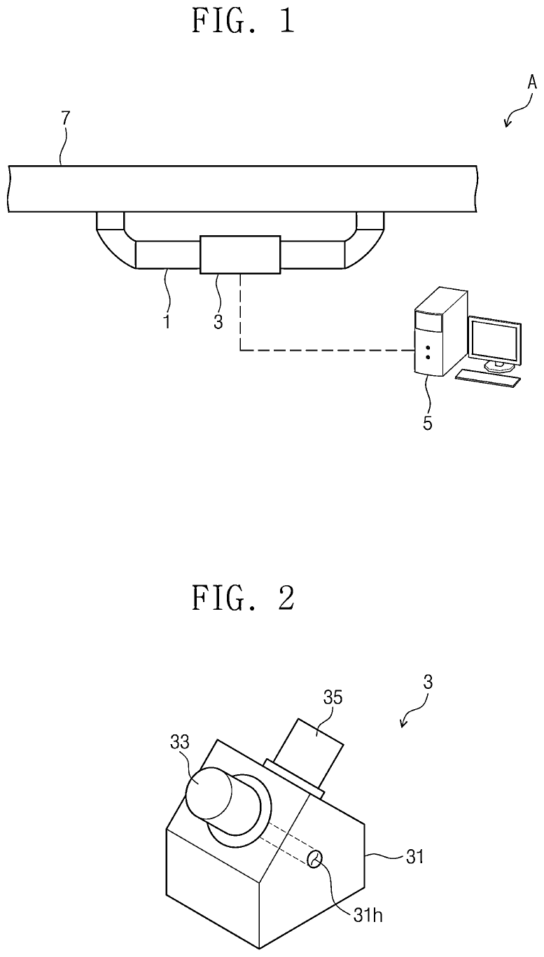

FIG. 1 is a schematic diagram illustrating a fluid monitoring device according to an embodiment of the inventive concept.

Referring to FIG. 1, a fluid monitoring device A may be provided. The fluid monitoring device A may monitor a fluid flowing in a flow path. More specifically, the fluid monitoring device A may analyze information about particles in the fluid flowing in the flow path. For example, the fluid monitoring device A may analyze particles in the fluid and identify the type of the particles and determine the amount of the particles. To this end, the fluid monitoring device A may include a main flow path 7, an observation flow path 1, a fluid observation device 3, and a controller 5.

The main flow path 7 may be a flow path through which a fluid to be monitored flows. For example, the main flow path 7 may be a flow path through which lubricating oil used in a drive system that generates rotational power flows. That is, the fluid monitoring device A may monitor lubricating oil. However, the fluid monitoring device A is not limited to monitoring lubricating oil and may be used for other types of fluids as well.

The observation flow path 1 may be connected to the main flow path 7. More specifically, the observation flow path 1 may be connected in parallel to the main flow path 7. A part of the fluid flowing along the main flow path 7 may flow into the observation flow path 1. The fluid passing through the observation flow path 1 may return to the main flow path 7. The observation flow path 1 may be detachably connected to the main flow path 7. However, the observation flow path 1 is not limited thereto and may be fixed to the main flow path 7.

The fluid observation device 3 may be coupled to the observation flow path 1. The fluid observation device 3 may photograph the fluid passing through the observation flow path 1. More specifically, the fluid observation device 3 may photograph particles in the fluid passing through the observation flow path 1. Based on information obtained by photographing by the fluid observation device 3, the particles in the fluid may be analyzed. This will be described in detail below.

The controller 5 may be connected to the fluid observation device 3. The controller 5 may control the fluid observation device 3. In addition, the controller may receive information from the fluid observation device 3 and analyze the received information. This will be described in detail below.

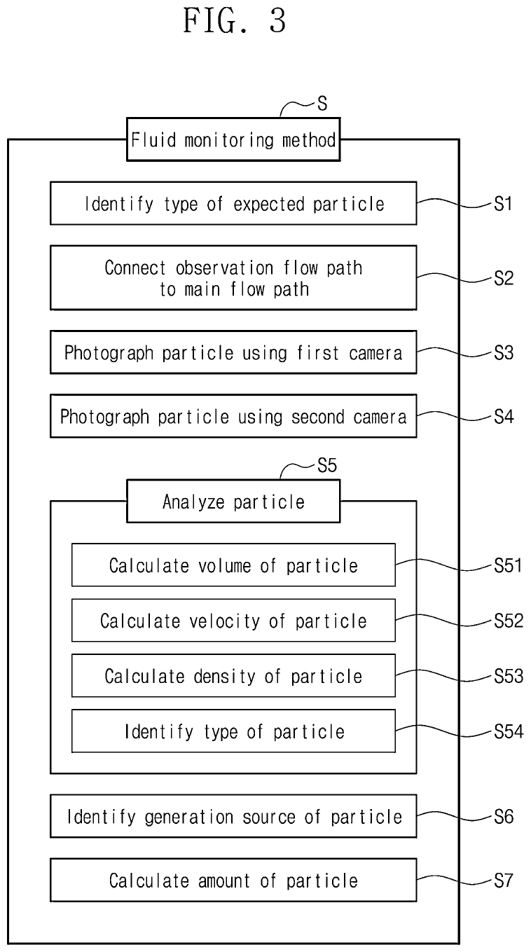

FIG. 2 is a perspective view illustrating a fluid observation device according to an embodiment of the inventive concept.

Referring to FIG. 2, the fluid observation device 3 may include an observation housing 31, a first camera 33, and a second camera 35.

The observation housing 31 may be coupled to the observation flow path 1. The observation housing 31 may provide a connection flow path 31h. The connection flow path 31h may be connected to the observation flow path 1. The fluid flowing along the observation flow path 1 may flow into the connection flow path 31h.

The first camera 33 may be coupled to the observation housing 31. The first camera 33 may photograph the fluid passing through the connection flow path 31h. More specifically, the first camera 33 may photograph the fluid flowing into the connection flow path 31h through the observation flow path 1. In this way, information on particles in the fluid may be obtained. In an embodiment, the first camera 33 may be coupled to the observation housing 31 at a certain angle. Accordingly, the first camera 33 may photograph a particle in the fluid at the certain angle.

The second camera 35 may be coupled to the observation housing 31. The second camera 35 may be spaced apart from the first camera 33. The second camera 35 may photograph the fluid passing through the connection flow path 31h. More specifically, the second camera 35 may photograph the fluid flowing into the connection flow path 31h through the observation flow path 1. In this way, information on particles in the fluid may be obtained. In an embodiment, the second camera 35 may be coupled to the observation housing 31 at a certain angle. More specifically, the second camera 35 may be coupled to the observation housing 31 at an angle different from that of the first camera 33. Accordingly, the second camera 35 may photograph a particle in the fluid at the angle different from that of the first camera 33. In this way, information on a size of the article in the fluid may be obtained. This will be described in detail below.

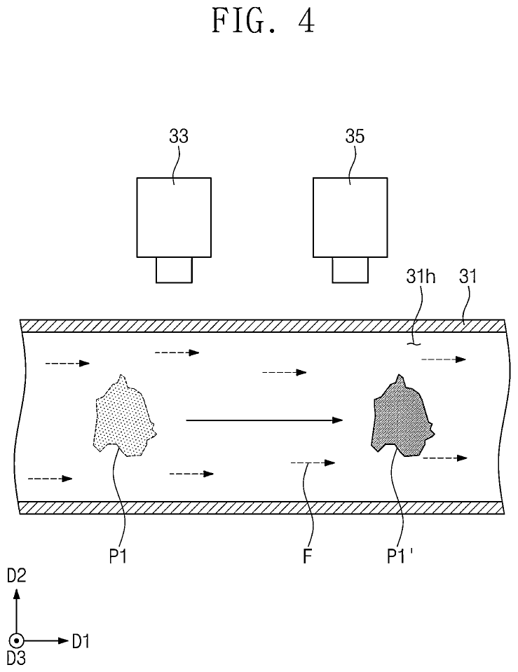

FIG. 3 is a flowchart illustrating a fluid monitoring method according to an embodiment of the inventive concept.

Referring to FIG. 3, a fluid monitoring method S may be provided. The fluid monitoring method S may be a method of monitoring the fluid using the fluid monitoring device A (see FIG. 1) described with reference to FIGS. 1 and 2. More specifically, the fluid monitoring method S may be a method of collecting and analyzing information on particles in a fluid using the fluid monitoring device A. To this end, the fluid monitoring method S may include identifying a type of an expected particle (S1), connecting an observation flow path to a main flow path (S2), photographing a particle using a first camera (S3), photographing the particle using a second camera (S4), analyzing the particle (S5), identifying a generation source of the particle (S6), and calculating an amount of the particle (S7).

The analyzing of the particle (S5) may include calculating a volume of the particle (S51), calculating a velocity of the particle (S52), calculating a density of the particle (S53), and identifying the type of the particle (S54).

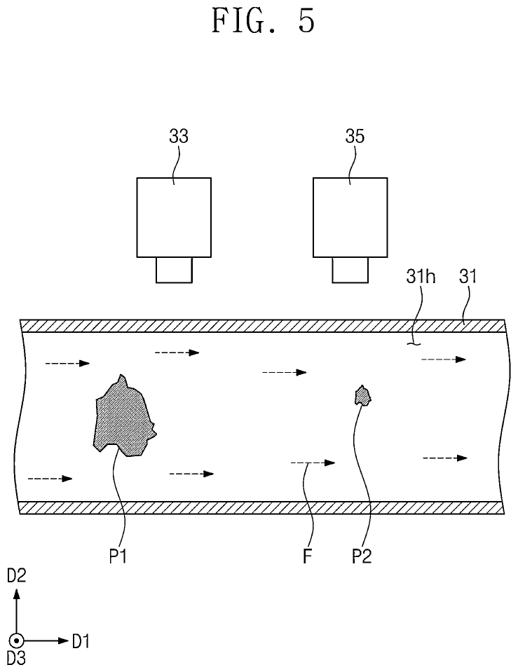

In the following, the fluid monitoring method S of FIG. 3 will be sequentially described with reference to FIGS. 4 to 6.

FIGS. 4 and 5 are diagrams illustrating the fluid monitoring method according to an embodiment of the inventive concept according to the flowchart of FIG. 3.

Hereinafter, D1 may be referred to as a first direction, D2 crossing the first direction D1 may be referred to as a second direction, and D3 crossing each of the first and second directions D1 and D2 may be referred to as a third direction.

Referring to FIG. 3, the identifying of the type of expected particle (S1) may include identifying a fluid is required to be monitored. More specifically, the type of fluid that is required to be monitored, a position of the fluid, and a purpose for which the fluid is used may be identified. In this way, it is possible to determine the type of expected particle to be predicted to be present in the fluid. For example, when the fluid is a lubricating oil used in a drive system that produces rotational power, a particle of a certain metal included in the drive system may be predicted to be present in the fluid. That is, it may be predicted that a portion of a component of the drive system is worn out and a certain metal particle separated from the component is present in the fluid. In this case, the certain metal particle may be the expected particle. There may be a plurality of certain metal particles. That is, it may be predicted that a plurality of expected particles is present in the fluid. However, the expected particle is not limited thereto, and may vary depending on the fluid. For example, when the fluid that is required to be monitored is a fluid flowing in a river or stream, the expected particle may be a microplastic or the like.

Referring to FIGS. 3 and 1, the connecting of the observation flow path to the main flow path (S2) may include coupling the observation flow path 1 to the main flow path 7 so that the observation flow path 1 is disposed in parallel to the main flow path 7. When the fluid is lubricating oil used in the drive system that produces rotational power, the main flow path 7 may be a circulation flow path coupled to the drive system. The observation flow path 1 may be coupled to one side of the main flow path 7 that circulates. However, the observation flow path 1 is not limited thereto and may be fixedly coupled to the main flow path 7. In this case, the connecting of the observation flow path to the main flow path (S2) may be omitted.

Referring to FIGS. 3 and 4, the photographing of the particle using the first camera (S3) may include photographing a particle P1 in the fluid F by the first camera 33. The fluid F may flow in the first direction D1 within the connection flow path 31h. The first camera 33 may photograph the particle P1 at a certain angle. In an embodiment, the photographing of the particle using the first camera (S3) may be performed a plurality of times. The first camera 33 may photograph one particle P1 a plurality of times. For example, the first camera 33 may photograph the same particle P1 at each of a first time and a second time. That is, the photographing of the particle using the first camera (S3) may be performed at each of the first time and the second time. More specifically, the particle P1 may be positioned at a first position at the first time. The first camera 33 may photograph the particle P1 at the first position at the first time. Then, the particle P1 may move in the first direction D1 by flow of the fluid F. Accordingly, a particle P1′ may be positioned at a second position at the second time. The first camera 33 may photograph the particle P1′ at the second position at the second time.

The photographing of the particle using the second camera (S4) may include photographing the particle P1 in the fluid F by the second camera 35. The second camera 35 may photograph the particle P1 at an angle different from that of the first camera 33. In an embodiment, the photographing of the particle using the second camera (S4) may be performed a plurality of times. The second camera 35 may photograph one particle P1 a plurality of times. For example, the second camera 35 may photograph the same particle P1 at each of the first time and the second time. That is, the photographing of the particle using the second camera (S4) may be performed at each of the first time and the second time. The second camera 35 may photograph the particle P1 at the first position at the first time. The second camera 35 may photograph the particle P1′ at the second position at the second time.

In an embodiment, each of the photographing of the particle using the first camera (S3) and the photographing of the particle using the second camera (S4) may be performed on a plurality of particles observed in the fluid F for a certain period of time. That is, a plurality of particles may be observed by each of the first camera 33 and the second camera 35. This will be described in detail below.

Referring back to FIGS. 3 and 4, the calculating of the volume of the particle (S51) may be performed by comparing an image captured by the first camera 33 and an image captured by the second camera 35. The first camera 33 and the second camera 35 photograph the particle P1 at different angles, which may be used to calculate the volume of the particle P1. That is, by comparing a shape of the particle P1 in the image captured by the first camera 33 and a shape of the particle P1 in the image captured by the second camera 35, three-dimensional information about the shape of the particle P1 may be grasped. Accordingly, the volume of the particle P1 may be calculated.

The calculating of the velocity of the particle (S52) may be performed by comparing the position of the particle P1 measured at the first time and the position of the particle P1′ measured at the second time. That is, the velocity of the particle P1 may be calculated by dividing a moving distance of the particle P1 by a time difference between the first time and the second time. The velocity of the particle P1 may be different from the velocity of the fluid F.

The calculating of the density of the particle (S53) may be performed using the volume of the particle P1 and the velocity of the particle P1. More specifically, when the volume of the particle P1 in the flowing fluid and the velocity of the particle P1 are known, the density of the particle P1 may be calculated as follows.

$${ρ}_{p} = \frac{18 \text{?} η}{{D}_{p} \text{?}} + {ρ}_{f} \qquad ( 1 )$$

$$\text{?} \text{indicates text missing or illegible when filed}$$

Referring to Equation (1), ρₚ denotes the density of the particle Dₚ denotes a radius of the particle P1. g denotes gravitational acceleration. v₁ denotes the velocity of the particle P1. n denotes a dynamic viscosity of the fluid F. ρ_{f} denotes a density of the fluid F. Therefore, when the volume of the particle P1 and the velocity of the particle P1 are known, the density of the particle P1 may be calculated.

Referring to FIGS. 3 and 5, the analyzing of the particle (S5) may include comparing a buoyant force of each of a plurality of particles. Each of the first camera 33 and the second camera 35 may photograph a plurality of particles. For example, each of the first camera 33 and the second camera 35 may photograph a first particle P1 and a second particle P2. The first particle P1 and the second particle P2 may be particles different from each other. More specifically, the first particle P1 and the second particle P2 may be particles composed of different materials. A buoyant force acting on the first particle P1 and a buoyancy force acting on the second particle P2 may be compared using the information on the first particle P1 and the second particle P2 captured by the first camera 33 and the second camera 35, respectively.

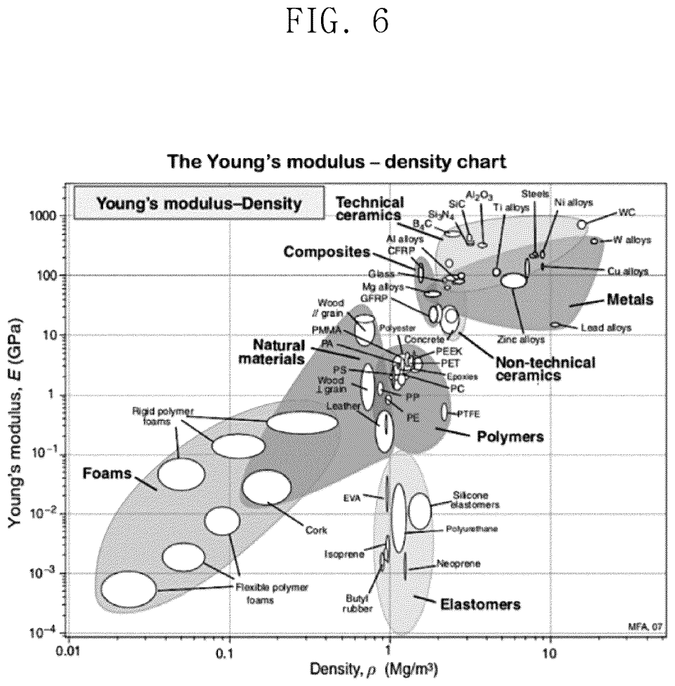

FIG. 6 is a graph showing Young's modulus-density chart.

Referring to FIG. 6, a horizontal axis may refer to a density of a material. A vertical axis may refer to a Young's modulus of a material.

Referring to FIGS. 6 and 5, the identifying of the type of particle (S54) may be performed using Young's modulus-density chart. When the density of the particle is known, the type of particle may be estimated using the graph of FIG. 6. Therefore, the type of the particle may be estimated using the particle density obtained in the calculating of the density of the particle (S53).

In an embodiment, the identifying of the type of the particle (S54) may further include selecting one from expected particles. For example, even when the density of the particle is known, there may be a plurality of types of particles that have been estimated from the Young's modulus-density chart. It may be unclear which of these particles the particle is. Therefore, among a plurality of expected particles, a material that overlaps with the type of particle estimated from the Young's modulus-density chart may be a constituent material of the particle. That is, the type of particle estimated from the Young's modulus-density chart may be corrected using the types of expected particles.

When the analysis of a plurality of particles is performed, the identifying of the type of the particle (S54) may further include correcting the type of the particle using a buoyant force of each of the plurality of particles. For example, even when the density of the particle is known, there may be a plurality of types of particles that have been estimated from the Young's modulus-density chart. It may be unclear which of these particles the particle is. Therefore, by comparing the buoyant forces of the plurality of particles with each other, the constituent material of the particle may be corrected. That is, by using the density of the particle and the buoyant force of the particle, the constituent material of the particle may be accurately identified.

Referring back to FIG. 3, the identifying of the generation source of the particle (S6) may include determining where the particle is generated using the type of the particle. For example, when the fluid is lubricating oil used in the drive system that produces rotational power, it is possible to determine which component of the drive system the particle has come off from. Accordingly, it is possible to diagnose the state of the drive system.

The calculating of the amount of the particle (S7) may include calculating an amount of a plurality of particles observed in the fluid for a certain period of time. Accordingly, it is possible to diagnose the state of the component through which the fluid passes. For example, when the fluid is lubricating oil used in the drive system that produces rotational power, it is possible to diagnose the degree of wear of the components of the drive system.

With the fluid monitoring method according to an embodiment of the inventive concept, it is possible to accurately determine the type of the particle in the fluid. Further, the fluid monitoring method may grasp the amount of the particle. Accordingly, it is possible to determine the state of the component through which the fluid passes and/or a contamination source.

With the fluid monitoring method according to an embodiment of the inventive concept, it is possible to monitor a fluid only with a camera without complicated equipment. That is, the state of the fluid may be diagnosed with only simple equipment.

With the fluid monitoring method according to an embodiment of the present invention, the flowing fluid may be monitored in real time in the field. Therefore, a quick and simple operation may be possible.

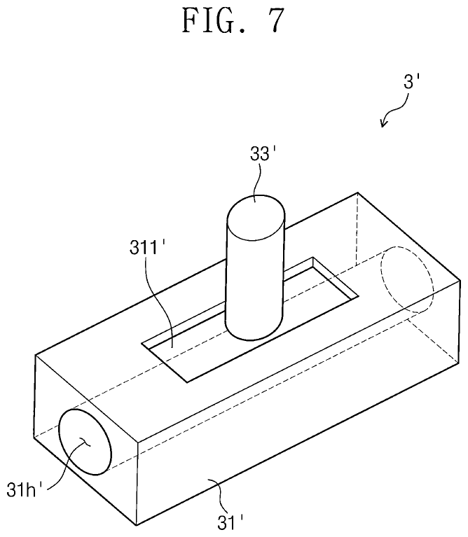

FIG. 7 is a perspective view showing a fluid observation device according to an embodiment of the inventive concept.

In the following, descriptions of contents that are substantially the same as or similar to those described with reference to FIGS. 1 to 6 may be omitted.

Referring to FIG. 7, a fluid observation device 3′ may be provided. The fluid observation device 3′ may include an observation housing 31′ and a stereo camera 33′.

The observation housing 31′ may provide a connection flow path 31h′. The connection flow path 31h′ may be connected to the observation flow path 1 (see FIG. 1). The observation housing 31′ may include an observation lens 311′. The connection flow path 31h′ may be observable from the outside by the observation lens 311′.

The stereo camera 33′ may be positioned on the observation housing 31′. The stereo camera 33′ may observe the connection flow path 31h′ through the observation lens 311′. One stereo camera 33′ may be provided, but the fluid observation device is not limited thereto.

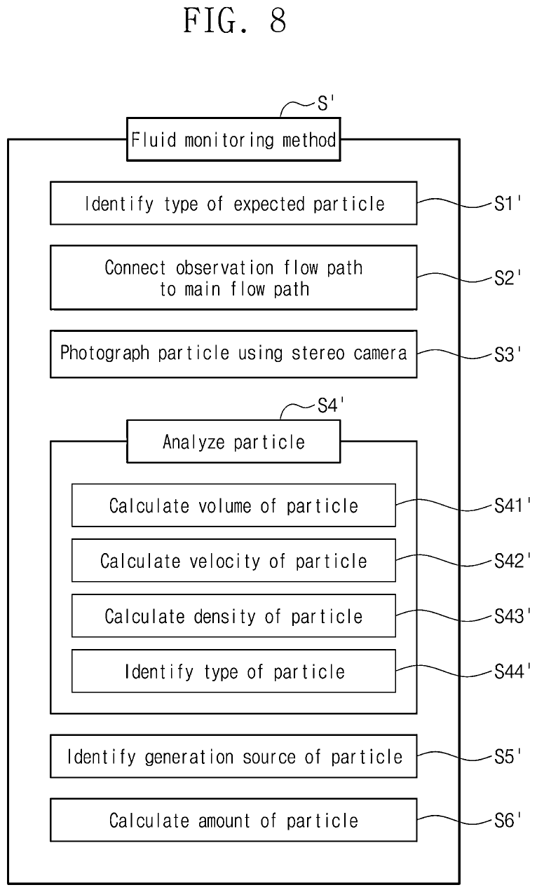

FIG. 8 is a flowchart illustrating a fluid monitoring method according to an embodiment of the inventive concept.

In the following, descriptions of contents that are substantially the same as or similar to those described with reference to FIGS. 1 to 7 may be omitted.

Referring to FIG. 8, a fluid monitoring method S′ may be provided. The fluid monitoring method S′ may be a method of monitoring the fluid using the fluid monitoring device A (see FIG. 1) including the fluid observation device 3′ described with reference to FIG. 7. The fluid monitoring method S′ may include identifying a type of an expected particle (S1′), connecting an observation flow path to a main flow path (S2′), photographing a particle using a stereo camera (S3′), analyzing the particle (S4′), identifying a generation source of the particle (S5′), and calculating an amount of the particle (S6′).

The analyzing of the particle (S4′) may include calculating a volume of the particle (S41′), calculating a velocity of the particle (S42′), calculating a density of the particle (S43′), and identifying the type of the particle (S44′).

Each of the identifying of the type of the expected particle (S1′), the connecting of the observation flow path to the main flow path (S2′), the analyzing of the particle (S4′), the identifying of the generation source of the particle (S5′), and the calculating of the amount of the particle (S6′) may be substantially the same as or similar to the corresponding one of those that have been described with reference to FIG. 3.

In the photographing of the particles using the stereo camera (S3′), unlike the description with reference to FIG. 3, the particle in the fluid may be photographed using one stereo camera. Two images captured from different angles may be obtained using one stereo camera. However, the fluid monitoring method is not limited to one stereo camera, and two or more stereo cameras may be used. A more detailed description thereof will be given below.

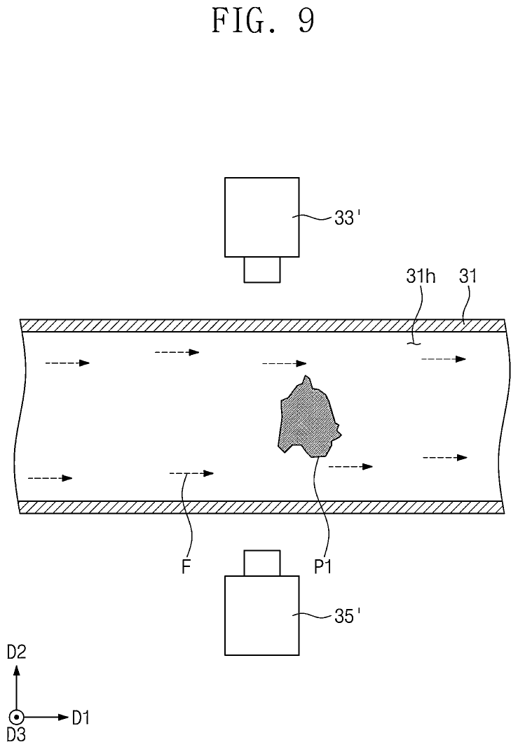

FIG. 9 is a diagram showing a fluid observation device according to an embodiment of the inventive concept.

In the following, descriptions of contents that are substantially the same as or similar to those described with reference to FIGS. 1 to 8 may be omitted.

Referring to FIG. 9, two stereo cameras may be provided. That is, a first stereo camera 33′ and a second stereo camera 35′ may be provided. The first stereo camera 33′ and the second stereo camera 35′ may be vertically spaced apart from each other. That is, the first stereo camera 33′ and the second stereo camera 35′ may be spaced apart in the second direction D2. The first stereo camera 33′ may be positioned above the connection flow path 31h. The second stereo camera 35′ may be positioned under the connection flow path 31h. However, the arrangement of the stereo cameras is not limited thereto, and the two stereo cameras may be spaced apart from each other in the horizontal direction.

According to a fluid monitoring method of an embodiment of the inventive concept, it is possible to identify the type of particles in a fluid.

According to a fluid monitoring method of an embodiment of the inventive concept, it is possible to grasp the amount of particles in a fluid in real time.

According to a fluid monitoring method of an embodiment of the inventive concept, it is possible to determine the state of a contamination source contaminating a fluid.

According to a fluid monitoring method of an embodiment of the inventive concept, it is possible to monitor a fluid with simple equipment.

According to a fluid monitoring method of an embodiment of the inventive concept, it is possible to monitor a flowing fluid in real time.

Effects of the present disclosure are not limited to those mentioned above, and other effects not mentioned will be clearly understood by those skilled in the art from the description below.

In the above, the embodiments of the inventive concept have been described with reference to the accompanying drawings, and those of ordinary skill in the art to which this subject matter pertains could understand that the additional or alternative embodiments may be embodied in other specific forms without departing from the technical spirit or essential features of the present disclosure. Therefore, it is to be appreciated that the embodiments described above are intended to be illustrative in all respects and not restrictive.

What is claimed is:

1. A fluid monitoring method comprising:
photographing a particle in a flowing fluid using a first camera;
photographing the particle using a second camera spaced apart from the first camera; and
analyzing the particle using images captured by each of the first camera and the second camera,
wherein the analyzing of the particle includes:
calculating a volume of the particle;
calculating a velocity of the particle moving in the fluid;
calculating a density of the particle using the volume and the velocity; and
identifying a type of the particle using the density.

2. The fluid monitoring method of claim 1, further comprising identifying a generation source of the particle using information on the identified type of the particle.

3. The fluid monitoring method of claim 1, further comprising identifying types of a plurality of expected particles to be expected to be present in the fluid,
wherein the identifying of the type of the particle includes selecting one of the plurality of expected particles using the density of the particle.

4. The fluid monitoring method of claim 1, wherein the identifying of the type of the particle is performed using a Young's modulus-density chart.

5. The fluid monitoring method of claim 1, wherein each of the photographing of the particle using the first camera and the photographing of the particle using the second camera is performed at each of a first time and a second time, and
the calculating of the velocity of the particle includes calculating the velocity of the particle using a position of the particle at the first time and a position of the particle at the second time.

6. The fluid monitoring method of claim 1, wherein each of the photographing of the particle using the first camera and the photographing of the particle using the second camera is performed on a plurality of particles for a certain period of time.

7. The fluid monitoring method of claim 6, further comprising calculating an amount of the plurality of particles observed in the fluid for the certain period of time.

8. The fluid monitoring method of claim 1, wherein the first camera and the second camera photograph the particle at different angles.

9. The fluid monitoring method of claim 8, wherein the calculating of the volume of the particle is performed by comparing the image captured by the first camera with the image captured by the second camera.

10. A fluid monitoring method comprising:
photographing a particle in a flowing fluid using a stereo camera; and
analyzing the particle using an image captured by the stereo camera,
wherein the analyzing of the particle includes:
calculating a volume of the particle;
calculating a velocity of the particle moving in the fluid; and
calculating a density of the particle using the volume and the velocity.

11. The fluid monitoring method of claim 10, wherein the analyzing of the particle further includes identifying a type of the particle using the density.

12. The fluid monitoring method of claim 11, wherein the photographing of the particle using the stereo camera is performed on a plurality of particles for a certain period of time, and
the analyzing of the particle includes comparing buoyant forces of the plurality of particles with each other.

13. The fluid monitoring method of claim 12, wherein the identifying of the type of the particle includes correcting the type of the particle identified by the density using a buoyant force of each of the plurality of particles.

14. The fluid monitoring method of claim 10, further comprising connecting an observation flow path disposed in parallel with a main flow path through which the fluid flows to the main flow path,
wherein in the photographing of the particle using the stereo camera, the stereo camera photographs the particle passing through the observation flow path.

15. A fluid monitoring method comprising:
photographing a plurality of particles in a flowing fluid using a camera; and
analyzing the plurality of particles using an image captured by the camera,
wherein the analyzing of the plurality of particle includes:
calculating a volume of each of the plurality of particles;
calculating a velocity of each of the plurality of particles moving in the fluid;
calculating a density of each of the plurality of particles using the volume and the velocity;
comparing buoyant forces of the plurality of particles with each other; and
identifying a type of each of the plurality of particles using the buoyant force and the density.

16. The fluid monitoring method of claim 15, wherein the photographing of the plurality of particles using the camera is performed using a first camera and a second camera spaced apart from the first camera.

17. The fluid monitoring method of claim 15, wherein the photographing of the plurality of particles using the camera is performed using a stereo camera.
